(19) United States
(12) Patent Application Publication
(10) Pub. No.: US 2011/0255212 A1
(43) Pub. Date: Oct. 20, 2011

(54) Carbon Nanotube Nanocomposites, Methods of Making Carbon Nanotube Nanocomposites, and Devices Comprising the Nanocomposites

(75) Inventors: Tao Liu, Tallahassee, FL (US); Bhima R. Vijayendran, Kuala Lumpur (MY); Abhihek Gupta, Charlotte, NC (US); Seung Min Paek, Seoul (KR)

(73) Assignee: BATTELLE MEMORIAL INSTITUTE, Columbus, OH (US)

(21) Appl. No.: 12/439,535

(22) PCT Filed: Aug. 31, 2007
(86) PCT No.: PCT/US07/19125

§ 371 Date: Jul. 4, 2011

Related U.S. Application Data
(60) Provisional application No. 60/841,741, filed on Sep. 1, 2006.
(60) Provisional application No. 60/841,743, filed on Sep. 1, 2006.

(51) Int. Cl. H01G 9/155; B05D 5/12; H01B 5/00; H01B 1/04; B82Y 40/00; B82Y 99/00

(52) U.S. Cl. 361/502; 174/126.2; 252/62.3 E; 427/79; 977/742; 977/842

(57) ABSTRACT

The invention describes nanocomposites containing carbon nanotubes (CNTs), methods of making the nanocomposites and devices using the nanocomposite materials. Combining CNTs with capacitor materials such as VN provides composite materials having unique supercapacitor properties.

### RELATED APPLICATIONS

This application claims the benefit of priority from provisional U.S. patent application Ser. Nos. 60/841,741 and 60/841,743, both of which were filed on Sep. 1, 2006.

### INTRODUCTION

Supercapacitor or electrochemical capacitors are being investigated and developed around the world for the applications such as backup power supply for memories, microcomputers, system boards, and clocks. In addition, supercapacitors can also be used in the electric and fuel cell vehicles to boost acceleration and restore the braking energy. Commercial products of electrochemical supercapacitors in the current markets are based on high surface area porous carbon materials as well as transition metal dioxide systems. See B. E. Conway. Electrochemical Supercapacitors, Scientific Fundamental and Technological Applications, Plenum Publishers, 1999. Commercial supercapacitors are widely used as standby power for random access memory devices, and telephone equipments, etc. As a measure of the charge storage capability, the specific capacitance for carbon based materials is typically around 100-200 F/g; and RuO2 can be as high as ˜750 F/g. See Kotz et al., “Principles and applications of electrochemical capacitors,” Electrochimica Acta 45, 2483-2498 (2000).

Electrically conducting metal oxide, conducting polymer and carbon have been studied for use as the active electrode materials for a supercapacitor. Different carbon polymorphs attracted intensive interests due to their balanced electrical conductivity, specific surface area, chemical stability and cost performance ratio. As a measure of the charge storage capability, the specific capacitance for carbon based materials is typically around 100-200 F/g. Carbon nanotube/carbon composites with randomly dispersed carbon nanotubes (CNTs) have been described by Liu et al. in “SWNT/PAN composite film-based supercapacitors,” Carbon 41, 2437-2451 (2003) and U.S. Pat. No. 7,061,749. Other CNT composites for supercapacitors have been described by Pushparaj et al. in “Flexible energy storage devices based on nanocomposite paper,” PNAS, 13574-13577 (2007). Ito in U.S. Pat. No. 6,475,670 described making composites for porous electrodes in which conductive fine particles are connected by a rubber type binder. Wong et al. in U.S. Pat. No. 7,189,455 described CNT composites in which RuO₂ is covalently bonded to the CNTs. Some CNT composites with TiN particles have been described by Jiang and Gao in “Fabrication and Characterization of Carbon Nanotube-Titanium Nitride Composites with Enhanced Electrical and Electrochemical properties,” J. Am. Ceram. Soc., 156-161 (2006) and “Carbon nanotubes-metal nitride composites: a new class of nanocomposites with enhanced electrical properties,” J. Mater. Chem. 260-266 (2005). Composites of carbon nanotubes with vanadium oxide have also been developed. See Sakamoto et al., “Vanadium Oxide-Carbon Nanotube Composite Electrodes for Use in Secondary Lithium Batteries,” J. Electrochem. Soc. A26-A30 (2002). Ajayan et al., in “Structure of carbon nanotube-based nanocomposites,” J. Microscopy, 275-282 (1997) reported CNTs that were coated with a monolayer of vanadium oxide.

Recently, Choi et al. (Choi et al., Adv. Mater. 2006, 18, 1178-1182) reported the synthesis of nanocrystalline vanadium nitrides supercapacitor materials (1300 Farad/gram).

Nanocrystalline vanadium nitride materials may have disadvantages such as: polymer binders are needed for electrode processing, which will block the porous structure to reduce the available charge storage sites either due to electrical double layer or reversible surface redox reactions; use of polymer binder may decrease the electrical conductivity and deteriorate the power performance; aggregation of nanocrystalline VN particles can reduce the surface area and/or reduce the available charge storage sites. The significant difference on the specific surface area between the theoretically calculated value (˜80 m²/g) and the experimentally measured value (˜40 m²/g) may be an indication of the aggregation of nanocrystalline vanadium nitride particles.

Although there has been intensive research and numerous materials have been experimented with, there is a need to develop novel materials that can significantly improve the properties of supercapacitor devices with high charge storage capabilities.

### SUMMARY OF THE INVENTION

The present invention relates to novel, high performance, hybrid nanocomposites of carbon nanotube, e.g., with vanadium nitrides or vanadium oxides, that are particularly useful for electrical energy storage applications, in particular, supercapacitors. In preferred embodiments, a mechanically robust network formed by carbon nanotubes with a large aspect ratio reduces or eliminate the need for binder and maximizes the charge storage capability for the hybrid electrodes.

The capacitance properties of vanadium nitride (VN) and metal oxide based supercapacitors are based on redox type mechanism. Carbon nanotube based supercapacitors are based on double layer effect. By combining the two mechanisms in a hybrid approach we expect to achieve next generation super capacitors because of potential to create significantly higher surface area and charge holding capacity with a more robust design.

When an electrode prepared from nanocrystalline vanadium nitrides involves the use of polymer binders, the polymer binders may deleteriously affect performance in different ways, for example by 1) blocking the porous structure to reduce the efficiency of the formation of the electrical double layer; and/or 2) decreasing the electrical conductivity to deteriorate the power performance. In addition, aggregation of the nanocrystalline particles would reduce the available surface area that could have been used for formation of the charge storage sites. For example, the specific surface area of 6.33 nm spherical vanadium nanoparticles is calculated to be ˜80 m²/g, but the actual measured value is ˜40 m²/g. To overcome the aforementioned problems in nanocrystalline vanadium nitrides supercapacitor electrodes, the present invention uses a carbon nanotube/nanocrystalline vanadium nitrides hybrid approach to develop high performance supercapacitor electrode materials. This approach will enable novel hybrid electrode materials with advantages from both carbon nanotubes—high electrical conductivity, high surface area, and flexible pore structure control, mechanical robustness entangled network and nanocrystalline vanadium nitrides—multistage pseudo-capacitance charge storage mechanism. The charge storage mechanism can be varied by manipulating the structure and performance relationship of the CNTs and VN in the porous hybrid supercapacitor electrodes. Furthermore, it is believed that the in-situ synthesis of vanadium nitride in the presence of carbon nanotube arrays prevents nanocrystalline particles from aggregation so that charge storage sites are maximized.

In one aspect, the invention provides a CNT composite electrode material, comprising:

carbon, metal oxide particles or metal nitride particles intermingled with aligned CNTs. The carbon (if present) is not from the CNTs but originates from impregnation with a polymer that is subsequently carburized. In one preferred embodiment, the composite electrode comprises carbon intermingled with the aligned CNTs, wherein the composite has a specific capacitance of at least 10 F/g and wherein the composite comprises at least 85 weight % CNTs. In another preferred embodiment, the CNT composite comprises vanadium nitride particles intermingled with the aligned CNTs; preferably, the vanadium nitride particles comprise a VN core and a vanadium oxide exterior. In another preferred embodiment, the CNT composite comprises vanadium oxide particles intermingled with the aligned CNTs.

In another aspect, the invention comprises a composite electrode comprising CNTs and VN. Preferably, crystalline VN is intermingled with the CNTs.

In a further aspect, the invention provides a CNT composite material, comprising: CNTs intermingled with vanadium oxide or vanadium nitride. This material comprises a specific capacitance of at least 5 F/g. Preferably, the CNTs are aligned.

The invention also includes a supercapacitor comprising any of the composite materials described herein. Typically, the composite material forms at least a first electrode, and wherein the supercapacitor further comprises a first collector connected to the first electrode, a second electrode, a separator layer disposed between the first and second electrodes, and a second collector connected to the second electrode. In some embodiments, the first and second electrodes are each composed of the same type of composite material. Additionally, the invention provides electronic devices (such as a mobile phone) comprising a supercapacitor that includes any of the composite materials described herein.

In a further aspect, the invention provides a method of making a carbon nanotube and vanadium nitride containing composite, comprising: providing carbon nanotubes; combining the carbon nanotubes with vanadium nitride to form a composite material, and heating or drying the composite material. In a preferred embodiment, VN is added to a dispersion of CNTs. In some preferred embodiments, the CNTs are aligned. In some preferred embodiments, the mixture of VN and CNTs is sonicated to aid combining the materials. VN can be added as particles or a VN precursor can be reacted to form VN. In some embodiments, the VN is heated to form crystalline VN.

In another aspect, the invention provides a method of making a CNT composite, comprising:

providing CNTs aligned on a substrate; and (a) impregnating the aligned CNTs with a polymeric material; and carbonizing the polymeric material, or (b) impregnating the aligned CNTs with particles of a metal oxide or metal nitride or precursors to metal nitride or metal oxide particles. In a preferred method that uses step (a), the polymeric material comprises PAN, PVA, or PVC. In a preferred method that uses step (a), the carbonizing step is carried out by heating to at least 600° C. in an inert atmosphere. When step (b) is used, the invention provides a method of making an aligned carbon nanotube containing to composite, comprising: providing aligned carbon nanotubes and adding particles or precursors to impregnate the aligned CNTs; wherein the particles or precursors comprise vanadium nitride or vanadium oxide particles or precursors to vanadium nitride or vanadium oxide particles, and heating or drying the composite material.

In a further aspect, the invention provides a method of making a carbon nanotube and vanadium oxide containing composite, comprising: providing carbon nanotubes; combining carbon nanotubes with vanadium oxide to form a composite material, and thermally treating the composite material at a temperature of at least about 500° C. Preferably, the vanadium oxide is derived from a foam of vanadium oxide. It has been discovered that the thermal treatment step dramatically improves specific capacitance. Any of the inventive methods can be combined with various preferred steps as described in greater detail in the following sections. For example, the methods can include a step of peeling the composite off a substrate after it is dried.

In another aspect, the invention provides a method of making supercapacitor, comprising making a composite electrode by any of the foregoing steps (i.e., any of the steps of making a composite electrode) and sandwiching the composite electrode between a collector and a separator.

As is typical of patent terminology, “comprising” means including and permits other components. In any of the descriptions, the invention includes articles and methods where “comprising” can be replaced by the more limiting terms “consisting essentially of” and “consisting of.”

The present invention will be useful for making and using capacitors; for example for power storage in microcomputers, memories, clocks, portable computers, system boards, portable electronic devices, and printable electronic papers and displays, power backup for electronic devices such as CMOS logic circuits digital cameras, sound recording and/or music players, fire/smoke alarms, and office equipment. It is envisioned that SWNT/VN supercapacitors may provide the highest supercapacitance performance, and that the CNT hybrid composites, in various embodiments, can offer advantages in cost, durability, reliability, and smaller size.

### BRIEF DESCRIPTION OF THE DRAWINGS

FIG. 1 shows a typical constant current charging and discharging results for an electrode composition.

FIG. 2 shows constant charging-discharging results for hybrid electrodes formed from carbon nanotubes and vanadium compounds. The electrode performance was in the order (see Table I) 1>2>7>3, 4, 5>6>8.

FIG. 3 shows the specific capacitance of carbon nanotube/vanadium compounds hybrid electrodes measured using the constant current charging-discharging method (current level=0.5 mA).

FIGS. 4 and 5 show capacitance performance comparison for ex-situ and in-situ prepared carbon nanotube/vanadium compounds hybrid electrodes.

FIG. 6 shows the specific capacitance of as-prepared hybrid electrodes made by different approaches.

FIG. 7 shows the effect of heat-treatment on the capacitance performance of carbon nanotube/vanadium compound hybrid electrodes.

FIG. 8 illustrates a scheme for preparing vertically aligned CT/polymer composite film for supercapacitor applications.

FIG. 9 shows the CNT orientation effect on capacitance performance of activated MWNT/PAN composite film electrode.

### DETAILED DESCRIPTION

The term “carbon nanotubes” or “CNTs” includes single, double and multiwall carbon nanotubes and, unless further specified, also includes bundles and other morphologies. The invention is not limited to specific types of CNTs. Suitable carbon nanotubes include single-wall carbon nanotubes prepared by HiPco, Arc Discharge, CVD, and laser ablation processes; double-wall carbon nanotubes (DWNTs), single double triple wall carbon nanotubes, and multi-wall carbon nanotubes, as well as covalently modified versions of these materials. The CNTs can be any combination of these materials, for example, a CNT composition may include a mixture of single and multiwalled CNTs, or it may consist essentially of DWNT and/or MWNT, or it may consist essentially of SWNT, etc. CNTs have an aspect ratio (length to diameter) of at least 50, preferably at least 100, and typically more than 1000. For some examples, we used aligned MWNT obtained from MER Corp. having dimensions of 7±2 μm long by 140±30 nm diameter, and about 30 μm long by 35±10 nm diameter.

In many preferred embodiments, the CNTs are aligned. As the term is used herein, “aligned” means aligned in one direction. CNTs that are aligned in one direction are sold commercially and are widely recognized by persons working in the area of nanotechnology. Alignment in a film can be viewed by viewing the film in cross-section using scanning electron microscopy (SEM). In a preferred embodiment, at least 95% of the nanotubes (by mass) are within 10° of a single axis.

In some preferred embodiments, the aligned nanotubes are attached, at one end, to a substrate, preferably a metal substrate. In some preferred embodiments, the conductive substrate is conductive and can subsequently be used as a current collector in a supercapacitor. Some preferred metal substrates comprise copper, aluminum, nickel, or stainless steel. Alternatively, a composite comprising CNTs can be formed on a substrate, then peeled off the substrate for additional processing and/or placement in an electronic device. In some preferred embodiments, the composite electrode is clamped or otherwise fixed within a supercapacitor.

The inventive supercapacitors utilize a conventional structure of (collector:electrode:separator:electrode:collector). One or both electrodes comprises the CNT composite materials described herein. Separators are known in the art and typically comprise a porous polymer and/or an electrolyte. As is known, the supercapacitors can be stacked and connected in series or parallel. In some preferred embodiments, the supercapacitor has a thickness less than 50 μm, in some embodiments, in the range of 10 micrometer (μm) to 100 μm.

The term “intermingled” means that particles are interspersed or bonded throughout a forest of CNTs, and not merely layered on top of a layer of CNTs. Typically, the particles decorate the outermost walls of individual CNTs and occur throughout an aligned array. The distribution can be viewed by SEM. The intermingled particles can be bonded to the CNTs, but in some preferred embodiments are held in the CNTs by electrostatic forces. In some embodiments, a binder can be used to assist in bonding particles to CNTs; when a binder is used it is preferably present in less than 10% by weight, in some embodiments in the range of 2 to 6%. In some embodiments, a CNT array can be sonicated during or after treatment with an infiltrant (such as a metal oxide particle or precursor, metal nitride particle or precursor, or thermally decomposable polymer).

In a broad aspect, the CNT composites can comprise inorganic compounds such as metal oxides (for example, Group V metal oxides) or metal nitrides selected for their desired electrical properties. In some embodiments, the particles may comprise ruthenium oxide, iridium oxide, manganese oxide, titanium oxide, osmium dioxide, molybdenum dioxide, rhodium oxide, tungsten oxide and mixtures of these. Most preferably, the particles are vanadium oxide or vanadium nitride or mixtures of vanadium oxide and nitride. The mass percent of particles in the composite can range from 1 to 99%. In some embodiments, the composite comprises more than 5 mass % particles, in some embodiments more than 70%, in some embodiments 70 to 98%.

The vanadium oxide particles, in their neutral state, have the formula V₂O₅ (vanadium pentoxide). The vanadium nitride particles, preferably have a core and sheath morphology with vanadium nitride in the core and vanadium oxide in a layer making up the exterior of the particle. The particles in the composites preferably have a particle size (mass average) of between 1 and 50 nm (as measured in the largest dimension), more preferably in the range of 2 to 10 nm

### Synthetic Methods

### A. CNT/Polymer Composite

This method begins with aligned CNTs, preferably an array of aligned CNTs that are attached to a surface (in some embodiments a metal surface). The CNTs are then impregnated with a thermally decomposable polymeric material. The polymeric material can be single type or blend of polymers and can be neat or dispersed (preferably dissolved) in a solvent. Some examples of polymers and solvents that can be used in this method are described in U.S. Pat. No. 7,061,749.

The impregnation step can be conducted by dripping polymer or polymer-containing solution onto the surface of a film of aligned CNTs. Alternatively, the aligned CNTs can be immersed in a molten polymer or a polymer-containing solution. In yet another alternative, monomers can be impregnated within an array of aligned CNTs and polymerized within the array.

Any thermally decomposable polymer can be used in broad aspects of the invention. Preferred polymers can be transformed into activated carbon such as polyacrylonitrile (PAN), styreneacrylonitrile (SAN), polystyrene (PS), phenolic resins, phenol formaldehyde resin, polyacenaphthalene, polyacrylether, polyvinylchloride (PVC), polyvinylalcohol (PVA), polyvinylidene chloride, poly(p-phenylene terephthalamide), poly-L-lactide, polyimides, polyurethanes, nylons, polyacrylonitrile copolymers, such as poly(acrylonitrile-methyl acrylate), poly(acrylonitrile-methyl methacrylate), poly(acrylonitrile-itaconic acid-methyl acrylate), poly(acrylonitrile-vinyl pyridine), poly(acrylonitrile-vinyl chloride) and poly(acrylonitrile-vinyl acetate), and combinations thereof.

In embodiments where solvent is used to disperse the polymeric material, any solvent that will solubilize or suspend the polymer can be used to prepare a polymer solution to facilitate impregnating the nanotubes. For example, dimethylformamide (DMF) can be used to suspend or solubilize acrylonitrile-containing polymers and other polymers that can be converted to activated carbon.

After the aligned CNTs have been impregnated, the remaining solvent, if any, is removed from the polymer-nanotube composite. Any known means for removing the solvent from the polymer-nanotube form may be used. Examples of means for removing solvent, include, but are not limited to, vacuum drying, ambient evaporation, heating, coagulating the polymer-nanotube suspension in a non-solvent, or combinations thereof.

At any time after removing the solvent, if any, from the polymer-nanotube mixture, the form, such as a film, can, optionally, be cut into pieces of a desired shape.

The polymer-containing composite is then subjected to thermal treatment. Optionally, the composite can be treated in an oxidative environment at a temperature sufficient for partial reaction, preferably in the range of 200° C. to 1000° C., and in some embodiments in the range of 200° C. to 300° C. Examples of oxidative environments include, but are not limited to, air, steam, carbon dioxide, oxygen diluted in nitrogen or an inert gas, and combinations thereof. Treatment in an oxidative environment can occur before and/or after carbonization (see below). An important advantage of treatment after carbonization is that it increases the porosity of the composite material.

The polymer-nanotube composite is carbonized by heat treating in a non-oxidizing or inert atmosphere. During carbonization, non-carbon elements of the polymer are removed as volatile byproducts. Any non-oxidizing or inert environment conducive for carbonizing the polymer may be used. Suitable environments that can be used are a vacuum (preferably less than 20 mm Hg), or alternatively, nitrogen, an inert gas, such as argon, or combinations thereof. “Carbonization” means to convert the polymer primarily to carbon. Carbonization is typically done at high temperature (at least 500° C.) in a non-oxidizing environment. More preferably, carbonization is carried out at a temperature of at least 600° C.

Each thermal treatment is preferably carried out for at least 30 seconds, and in some embodiments in the range of one minute to one day.

Optionally, the composites can also be treated by chemical activation, typically to increase porosity. Chemical activation involves the thermal decomposition of precursor materials impregnated with chemical agents, such as potassium hydroxide, zinc chloride, sodium carbonate and phosphoric acid. The chemical agents can promote the formation of crosslinked matrices that are less susceptible to volatilization and contraction during carbonization. In the chemical activation of a polymer-nanotube composite, a chemical agent, such as potassium hydroxide, zinc chloride, sodium carbonate or phosphoric acid, is added to the polymer-nanotube mixture. The addition and mixing of the chemical agent into the polymer-nanotube mixture can be done at any time prior to forming the polymer-nanotube mixture into a composite form.

### B. CNT/Vanadium Oxide or Nitride Nanocomposite

In some cases, particles of a metal oxide or metal nitride (preferably V₂O₅ or vanadium nitride) are combined with CNTs. Preferably the materials are sonicated together to improve dispersion of the two phases into each other. In some other cases, chemical precursors (such as VCl4 and NaNH2) are combined with CNTs and the metal nitride is formed in the presence of CNTs; optionally, this process could be conducted simultaneously with sonication. Preferably, the reaction and combining steps are conducted at room temperature. Subsequently, an intermediate product is obtained, typically by filtration or centrifugation. The solid nanocomposite is then calcined, preferably at a temperature of at least 400° C., more preferably at least 500° C., and in some embodiments in a range of 400 to 700° C.

### Properties

The nanocomposites of the invention are particularly useful as capacitor materials. Preferably, the nanocomposites have a specific capacitance of at least 5 F/g, more preferably at least 10 F/g, still more preferably at least 20 F/g, more preferably at least 50 F/g, at least 100 F/g. It is contemplated that preferred materials will have a specific capacitance of at least 1000 F/g, more preferably at least 1500 F/g, and in some embodiments in the range of 50 to about 2000 F/g.

The inventive materials also can exhibit high electrical conductivities (which may be isotropic or, in some preferred embodiments, anisotropic). The electrical conductivity is preferably at least 100 S/cm, more preferably 1000 S/cm and in some embodiments in the range of 0.1 s/cm to about 10,000 S/cm or higher. For thin film electrode samples, the standard 4-probe electrical testing method can be used to determine the in-plane sheet resistance R₁. The 2-probe method is used for through-plane electrical resistance R₂ measurement. Given the film thickness t, which can be determined using micrometer, profilomer, AFM, or SEM whichever is appropriate, the electrical conductivity is calculated by t/R₁ for in-plane and t/(R₂A) for through plane (A is the contact area between the probe and the film in 2-probe measurement).

The surface area of the nanocomposite materials are preferably at least 100 m²/g, more preferably at least 500 m²/g and in some embodiments 100 to about 1300 m²/g.

The composite materials (preferably in the form of an electrode in a supercapacitor) are preferably in the form of a film, preferably a film that has an array of CNTs that are aligned perpendicular to the surface of the film (that is, parallel to film thickness). In some preferred embodiments, the films are 100 nm or less in thickness, in some embodiments in the range of 1 μm to 1 mm thick, in some embodiments in the range of 20 μm to 50 μm, and in some embodiments in the range of 30 to 500 nm in thickness. The composites are preferably porous, preferably having a median pore size (median by volume) of 50 nm or less, more preferably in the range of 1 to 20 nm Pore size can be measured by BET and/or Hg porosimetry.

The carbon nanotubes are preferably aligned with nanocrystals intermingled with the CNTs (as opposed to separate layers of CNTs and nanocrystals).

In preferred embodiments, the CNT/carbon composite material has a specific capacitance (measured as an average from charging and discharging) of at least 10 F/g, more preferably at least 20 F/g, and in some embodiments up to about 50 F/g, in some embodiments up to about 40 F/g. In some preferred embodiments, the composite is made from (or contains) at least 85% CNTs, more preferably at least 90% (by weight) CNTs, and in some embodiments 85 to 99%, in some embodiments, 80 to about 95 weight % CNTs; with the remainder being polymer (solvent is excluded from these weight percentages). Although the capacitance develops from carburizing and, optionally, activating, the invention is not limited to the final product but may include intermediate composite compositions.

### Examples

### 1. Nanocrystalline Vanadium Nitrides

Nanostructured VN powder was synthesized by Choi et al. Carnegie-Mellon University (as noted above) by the reaction of ammonia gas with VCl4 solution in chloroform. Subsequent passivation with oxygen is carried out at 400° C. The Choi et al. approach for synthesis of VN requires large amounts of ammonia (NH₃). We used a simpler and safer synthetic method in which VCl₄ is reacted with NaNH₂: see Chen et al., “A room-temperature synthesis of nanocrystalline vanadium nitride,” Solid State Comm., 343-346 (2004).

The procedures are:

Liquid phase reaction VCl₄+4NaNH₂=VN+4NaCl+N₂+NH₃+5/2H2
Inert-environment—No moisture/oxygen
Mixtures of Vanadium oxides/nitrides can be obtained if some oxygen is present.

The two-step (also termed “ex-situ”) formation of Vanadium/Carbon nanotube hybrid electrodes used MWNT (purchased from MER company)—MRCSD (7±2 μm long by 140±30 nm diameter) and MRCMW (30 μm long by 35±10 nm diameter) used MWNT/Vanadium ratio of from 8.5 to 0.1. The vanadium compounds (prepared as described above) and MWNT (from a solution of 1 g dissolved in dimethylacetamide (30 g)) were mixed under sonication for 30 minutes; 5 wt % of PVDF was added as a binder material for film electrode preparation. The resulting dispersion was filtered onto alumina membrane (Anodisc, 0.2 μm of pore size) to make thin film electrodes, and dried in vacuum.

### Performance Evaluation and Definition of Specific Capacitance

Specific capacitance was measured by constant current charging/discharging at a current level of 0.5 mA using 6N KOH aqueous solution as the testing electrolyte. A Solatron 1260 frequency response analyzer equipped with Solatron1287 dielectric interface was used for performance evaluation.

The specific capacitance (capacitance per unit mass of a single electrode) was calculated as a function of discharging voltage using the formula where m_{A} and m_{B} are the masses of the two electrodes, I, V(t), and t are the discharging current, voltage and time, respectively.

$${C}_{sp} = \frac{I}{d V ( t ) / d t} ( \frac{1}{{m}_{A}} + \frac{1}{{m}_{B}} )$$

The schematic of a representative testing cell are described in U.S. Pat. No. 7,061,749B2 which is incorporated herein by reference as if reproduced in full below.

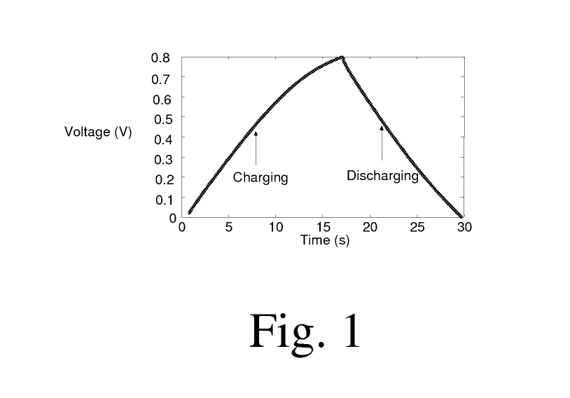

FIG. 1 shows a typical constant current charging and discharging results. Keeping current constant, say 0.5 mA, the supercapacitor is charged. With increasing time, voltage of the cell increases up to a pre-set value (0.8 V in our case) due to charge accumulated on the electrode. Discharging is just the reverse process, in which constant current (0.5 mA) is drawn from the charged cell to release the stored charges from the electrode.

For purposes of the present invention, “specific capacitance” refers to the measurement as described herein.

Following the sample preparation procedures described above, multiple hybrid electrodes were prepared and the compositions are given in Table I.

TABLE I
Composition of Carbon nanotube/Vanadium
compounds hybrid electrodes

| | Type of | | Weight percent (%) |
|---|---|---|---|
| | multi-wall | Inorganic | (carbon nanotube/inorganic |
| Electrode | carbon nanotube | component | component/PVDF) |
| 1 | MRCSD | Vanadium | 10/85/5 |
| 2 | MRCMW | Compounds | 10/85/5 |
| 3 | MRCSD | | 50/45/5 |
| 4 | MRCMW | | 50/45/5 |
| 5 | MRCSD | | 85/10/5 |
| 6 | MRCSD | | 50/45/5 |
| 7 | MRCSD | | 10/85/5 |
| 8 | MRCMW | | 85/10/5 |

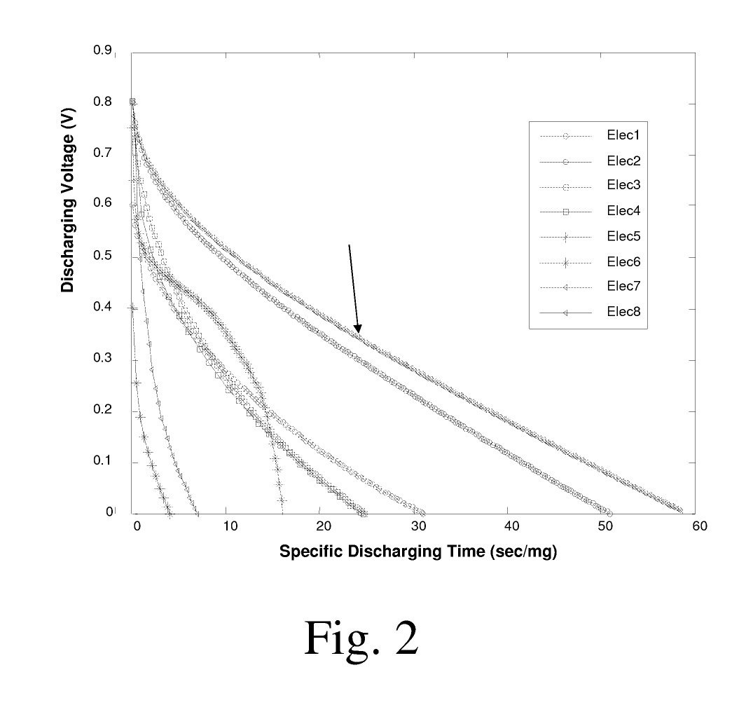

According to the performance evaluation procedures aforementioned, constant current-charging discharging testing was performed for the prepared hybrid electrodes, and the results are given in FIG. 2.

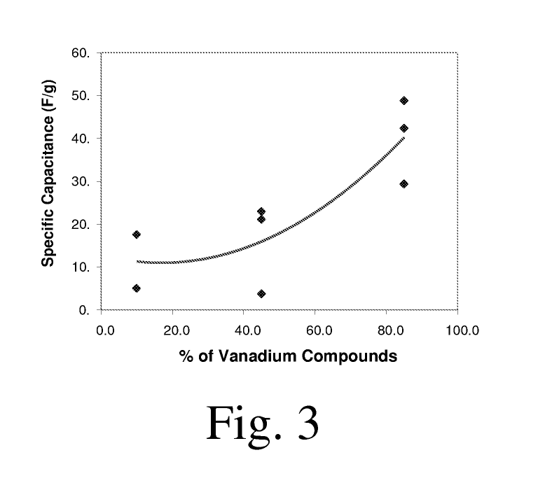

On the basis of the constant current charging-discharging results, the specific capacitance (F/g) of the hybrid electrodes were calculated using the formula given above and the result are given in FIG. 3.

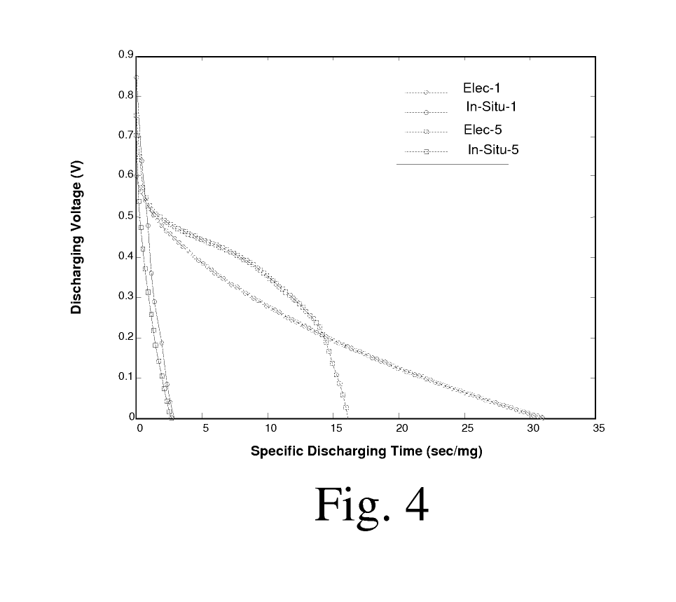

As a comparison to the two step approach for preparation of carbon nanotube/vanadium compounds hybrid electrodes, a one step (also termed “in-situ”) method was used to prepare the nanocomposite material. In contrast to post-mixing in the ex-situ to approach, carbon nanotubes were incorporated into to reactant mixture of VCl₄+4NaNH₂. Given the same electrode composition, the ex-situ-prepared hybrid electrodes exhibited superior performance as compared to those prepared by the in-situ approach. The constant current charging-discharging results as well as the specific capacitance for both in-situ and ex-situ prepared hybrid electrodes are shown in FIGS. 4 and 5 respectively. Specific discharging time (FIG. 4) is an alternative way to the specific capacitance equation to visualize the charge storage capability of a supercapacitor cell. The longer the specific discharging time, the higher the charge storage capability and the higher the specific capacitance. This plot is a direct result of DC constant current charging and discharging (a standard method for supercapacitor performance evaluation) but with time (t) divided by the reduced mass 1/(1/mA+1/mB). In FIG. 4, the longest specific discharge time is seen for Electrode 1, with much shorter times for the in-situ prepared electrodes.

### 2. Foams of Vanadium Oxides and the Corresponding Carbon Nanotube Hybrid Electrodes

V₂O₅ foams were prepared based on the procedures disclosed in Chandrappa et al. Nature, vol. 416, p. 702 (2002) as follows: 5 g of commercial vanadium oxide powder was reacted with 10 g of hexadecylamine in presence of 15 mL of acetone. After 15 min, homogeneous reaction mixture became a sticky paste. Subsequently, 250 mL of 30 wt. % H₂O₂ solution was added to the mixture. Foaming started immediately, and the obtained voluminous V₂O₅ foams, which were mixed with commercial multi-walled carbon nanotubes for preparing hybrid electrodes. An additional description of making a V₂O₅ foamed material and VN can be found in Krawiec et al., Adv. Mater. 2006, 18, 505-508.

Hybrid electrodes of carbon nanotube/foamed V2O5 were prepared with typical mass ratio between V₂O₅ foam and MRCSD (multi-walled carbon nanotubes, MER Company) of 85 wt. %/15 wt. % by: mixing V₂O₅ foam and MWNT (1 g) dissolved in dimethylacetamide (30 g) under sonication for 30 minutes; filtration of the resulting dispersion onto an alumina membrane (Anodisc, 0.2 μm of pore size) to make thin film electrodes, and dried in vacuum; followed by heating in a tube furnace at 600° C. for 1 hour under nitrogen atmosphere, and cooling to room temperature. The film thickness is preferably 1 um to 1 mm thick, more preferably 20 to 50 μm thick.

Electrochemical measurements were made on a two-electrode cell set-up. Two circular pieces of V₂O₅ foam-MRCSD films with a diameter of about 10 mm were sandwiched into a supercapacitor testing cell composed of two stainless steel current collectors and a hydrophilic polyethylene sheet separator. 6 M of KOH was used as an electrolyte for all the electrochemical measurements. Capacitance was cross-confirmed by constant current charging-discharging (CC) method and constant voltage charging-discharging (CV) method.

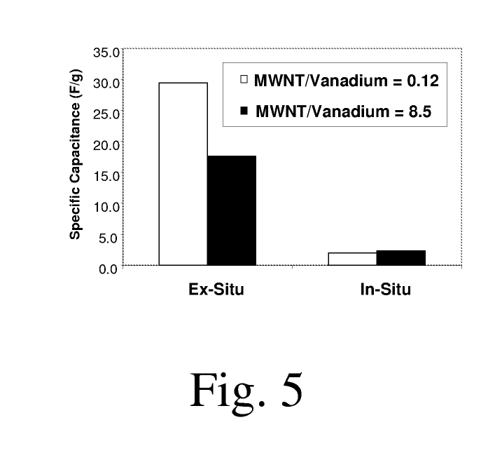

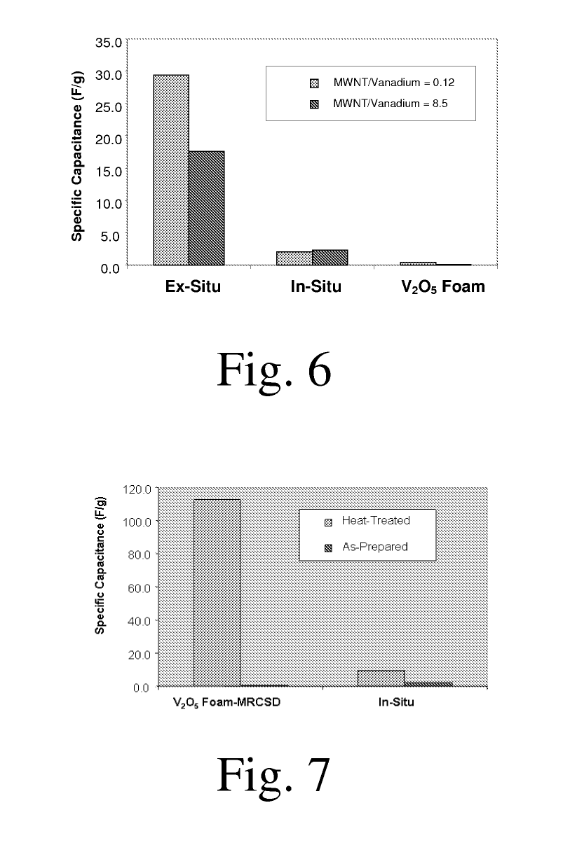

At the same electrode composition (MRCSD/Vanadium compound=8.5 and 0.12), as-prepared ex-situ, in-situ, foamed V₂O₅ hybrid electrodes were prepared and the specific capacitance was evaluated with constant current charging-discharging testing method. The specific capacitance results are given in FIG. 6, where the foamed V₂O₅ hybrid electrodes hardly show charge storage capability. However, we surprisingly discovered that after 600° C. heat-treatment of the foamed V₂O₅ hybrid electrodes, the capacitance performance enhanced dramatically (100×). The results are shown in FIG. 7. As shown in the same figure, contrary to foamed V₂O₅ hybrid electrodes, the in-situ approach prepared hybrid electrodes do not show significant performance enhancement by high temperature heat treatments.

### 3. Vertically Aligned Carbon Nanotube/Polymer Composite Film Based Supercapacitor Electrodes

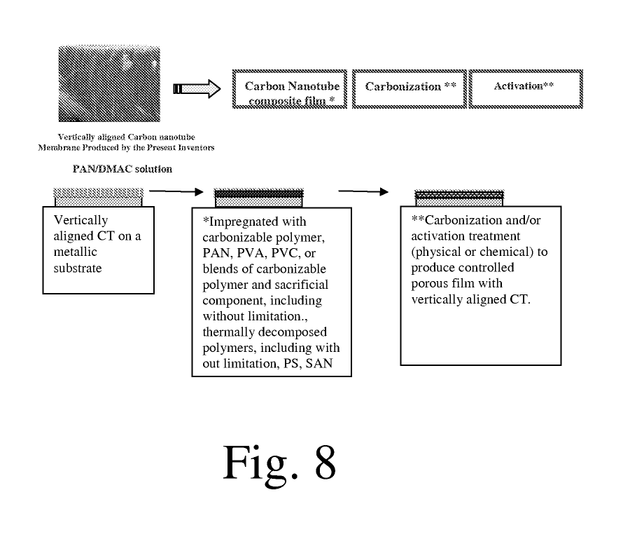

The schematic procedure for processing carbon nanotube/polymer composite film based supercapacitor electrode is shown in FIG. 8.

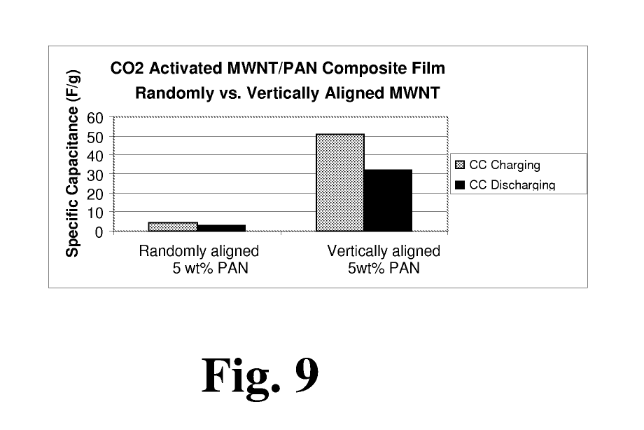

Following this procedure, we prepared vertically aligned MWNT/PAN composite film and evaluated the capacitance performance. In the sample tested, the film was impregnated, dried, peeled off the substrate, carbonized at about 700° C. in an inert atmosphere, activated with CO₂ at about 700° C. The sample contained 95 weight % CNT and 5 weight % PAN. Surprisingly, we discovered that the use of the of the vertically aligned CNT led to a dramatic improvement of capacitance performance as compared to a similar composite prepared from randomly aligned CNTs. The results are shown in FIG. 9.

1. A CNT composite electrode material, comprising:
carbon, metal oxide particles or metal nitride particles intermingled with aligned CNTs.

2. The CNT composite of claim 1 wherein the composite electrode comprises carbon intermingled with the aligned CNTs, wherein the composite has a specific capacitance of at least 10 F/g and wherein the composite comprises at least 85 weight % CNTs.

3. The CNT composite of claim 1 comprising vanadium nitride particles intermingled with the aligned CNTs.

4. The CNT composite of claim 3 wherein the vanadium nitride particles comprise a VN core and a vanadium oxide exterior.

5. The CNT composite of claim 1 comprising vanadium oxide particles intermingled with the aligned CNTs.

6. A composite electrode comprising CNTs and VN.

7. The composite electrode of claim 6 wherein crystalline VN is intermingled with the CNTs.

8. A CNT composite material, comprising:
CNTs intermingled with vanadium oxide or vanadium nitride; and
wherein the material comprises a specific capacitance of at least 5 F/g.

9. The CNT composite material of claim 8 wherein the CNTs are aligned.

10. A supercapacitor comprising the composite material of claim 1.

11. The supercapacitor of claim 10 wherein the composite material forms at least a first electrode, and wherein the supercapacitor further comprises a first collector connected to the first electrode, a second electrode, a separator layer disposed between the first and second electrodes, and a second collector connected to the second electrode.

12. The supercapacitor of claim 11 wherein the first and second electrodes are each composed of the same type of composite material.

13. A mobile telephone comprising the capacitor of claim 11.

14. A method of making a carbon nanotube and vanadium nitride containing composite, comprising:
providing carbon nanotubes;
combining the carbon nanotubes with vanadium nitride to form a composite material, and heating or drying the composite material.

15. The method of claim 14 wherein VN is added to a dispersion of CNTs.

16. The method of claim 15 wherein the dispersion containing VN and CNTs is sonicated.

17. The method of claim 14 wherein a VN precursor is added to aligned CNTs disposed on a substrate and wherein the VN precursor is reacted to form VN.

18. The method of claim 15 wherein VN is heated to form crystalline VN.

19. A method of making a CNT composite, comprising:
providing CNTs aligned on a substrate; and
(a) impregnating the aligned CNTs with a polymeric material; and carbonizing the polymeric material, or
(b) impregnating the aligned CNTs with particles of a metal oxide or metal nitride or precursors to metal nitride or metal oxide particles.

20. The method of claim 19 comprising impregnating the aligned CNTs with a polymeric material; and carbonizing the polymeric material.

21. The method of claim 20 wherein the carbonizing step is carried out by heating to at least 600° C. in an inert atmosphere.

22. A method of making a carbon nanotube and vanadium oxide containing composite, comprising:
providing carbon nanotubes;
combining carbon nanotubes with vanadium oxide to form a composite material, and thermally treating the composite material at a temperature of at least about 500° C.

23. The method of claim 22 wherein the vanadium oxide is derived from a foam of vanadium oxide.

24. The method of claim 19 comprising step (b) wherein the particles or precursors comprise vanadium nitride or vanadium oxide particles or precursors to vanadium nitride or vanadium oxide particles and further comprising heating or drying the composite material.

25. The method of any of claim 22 further comprising a step of peeling the composite off a substrate after it is dried.

26. A CNT composite electrode material made by the method of claim 20.

27. The CNT composite of claim 1 at least 95% of the carbon nanotubes (by mass) are within 10° of a single axis.
